(19) United States
(12) Patent Application Publication
(10) Pub. No.: US 2013/0206246 A1
(43) Pub. Date: Aug. 15, 2013

(54) SYSTEM FOR LIQUID LEAK CONTROL AND/OR AIR FLOTATION SYSTEM

(71) Applicant: Edward A. Chilcoat, Columbus, OH (US)

(72) Inventor: Edward A. Chilcoat, Columbus, OH (US)

(21) Appl. No.: 13/698,426

(22) PCT Filed: May 18, 2011
(86) PCT No.: PCT/US11/00882

§ 371 Date: Jan. 14, 2013

(51) Int. Cl. F17D 5/02

(52) U.S. Cl. CPC F17D 5/02
USPC 137/15.01; 137/565.37; 137/551

(57) ABSTRACT

Appliance pedestal that contains liquid leaks due to condensation, overflow, or system failure originating from the supported liquid filled or handling appliance, provides for multiple methods of discharge of collected liquids, and reduces installation and maintenance requirements and their associated hazards and provides an improved ergonomic operating position for the appliance operator. There is also a system to facilitate the movement of an appliance or pedestal supporting an appliance along a supporting surface. That system includes a chamber located at or proximate to the bottom of the appliance or pedestal having a plurality of openings formed therein. The chamber is pressurized to create a plurality of jets where fluid passes outwardly from the jets toward the supporting surface. The jets raise or float the appliance or the pedestal raising the appliance upwardly off of the supporting surface and allows the easy movement of the appliance along that supporting surface.

### FIELD OF THE INVENTION

The present invention relates to the field of appliances and, more particularly, to a system wherein the appliance includes an elevating and storage pedestal for the containment and proper discharge of liquids due to plumbing failure, seal failure, or mechanical failure within a liquid filled appliance such as, but not limited to, clothes washing machines, condensing clothes dryers, water heaters, dishwashers, refrigerators, icemakers, and similar devices and to an air flotation system for facilitating the moving of an appliance alone or an appliance located on a storage pedestal.

### BACKGROUND OF THE INVENTION

Damage to building structures and property can result from liquid leakage due to failures within a liquid filled, liquid handling, or liquid generating appliances. The damage can be quite significant especially in multi-family and multi-level structures. This risk of significant damage has also spurred the creation of building codes that require the installation of some system of control to prevent such damage in the event of liquid control failure within a piece of equipment.

The currently accepted method to catch and control leaks is the use of a shallow drip or catch pan that is placed between the appliance and the supporting surface immediately under the appliance. Installations have either no drain or they are plumbed to a drain and flow is accomplished by gravity. This method of control typically has five inherent primary shortcomings.

1. Machines must be lifted in or out of pan for installation and service or the pan must be of a multi-component configuration that must be assembled and sealed after the appliance has been put into position.

2. The shallow pans have limited retention capacity.

3. When a pan of this configuration is deepened to increase water retention capacity, the machine sits in the reservoir and can be damaged due to corrosion and electrically energized components are exposed to liquids creating potentially dangerous conditions.

4. The limited reservoir does not support a method for pumping liquids to an elevated drain or standpipe.

5. It does not address raising the appliance for improved ergonomic benefits.

This style of pan typically requires the installer or service technician to lift the appliance vertically in or out of the pan during installation or service of the equipment frequently resulting in damage to the pan or strain and injury to the service technician or both. Many times it requires two installers or service technicians to lift the machine in or out of such a pan resulting in higher installation and repair costs. Equipment installations in confined closet type installations are extremely difficult because technicians must lift the appliance from multiple sides where there is limited or no access. Installers or repair technicians must lift the entire weight of the appliance plus content mass if the appliance cannot be unloaded or drained.

The shallow cross section of the present art provides only a minimum liquid retention volume. Increasing height of the perimeter wall can increase the liquid retention volume but exacerbate the aforementioned installation and maintenance issues. Allowing these increased liquid levels can also increase direct damage to the appliance itself and create safety hazards such as liquid levels coming into contact with energized parts or submerging fuel gas supply systems.

Collection pan systems disclosed in the present art do not accommodate a necessary sump or volume area for the incorporation of a pump system to positively discharge liquids collected by the system to existing plumbing systems regardless of distance or elevation.

With the growing trend of front load washing appliances, a new market has developed for pedestals that raise the level of the machine to a more ergonomically acceptable height. Some of these pedestal designs incorporate additional storage area, usually in the form of a drawer. Raising the height of the machine reduces the stooping and bending necessary to load and unload the machine by the operator. Adjusting the height of such equipment is also a need to meet height requirements set forth by the ADA or Americans with Disabilities Act. The current art in elevating pedestals, such as those used to elevate laundry appliances, provide no means of leak control. The current art in leak control, the drip or catch pan, does not add any measurable height to the appliance installed within it.

One of the common problems with appliances today is in the lack of mobility, that is, whether the appliance is a dishwasher, clothes washer, dryer or the like, the appliance may be located among cabinets, other appliances, possible in a small room where the ability to access the appliance for moving the same is limited.

The problem is particularly acute during repairing the appliance by technicians who normally must move the appliance away from a wall or other barrier to obtain sufficient access to the appliance in order to carry out some repair thereof. With many appliances, it requires two technicians to move the appliance; therefore the cost of that repair is increased by the need to have an additional technician on the scene to manipulate the appliance into and out of a particular location.

Accordingly, it would be advantageous if there were a system that would facilitate the movement of an appliance, and particularly if that appliance could be readily moved to gain access thereto by only one technician or other person.

The purpose of the present invention is to effectively contain liquid leaks originating from appliances and support devices supported by the invention, provide multiple methods of retention and disposal of the captured liquids and provide for improved ease of installation and maintenance of said equipment, while providing an ergonomic improvement by raising the height of such installations.

### BRIEF SUMMARY OF THE INVENTION

This invention incorporates the functions of liquid leak control collection and disposal into an appliance elevating pedestal into a single device. It provides liquid control in both passive and active manners. For passive control, the invention directs leaking liquids to the incorporated retention sump out of contact with the appliance. The collected liquid may be retained or discharged by means of an incorporated gravity drain. The invention provides active control by supplying space for the incorporation of a pump for discharging collected liquids to an elevated or distant plumbing system such as a standpipe. The invention eliminates the need for lifting the full weight of the appliance. The invention does not need to be mounted to the appliance eliminating much of the handling requirements for the installation of a pedestal. It facilitates installation and maintenance of the supported appliance from the front of the invention by one person. It provides for mounting to the supporting surface to prevent “creeping” of the appliance by inertia generated by earthquake or “out of balance” conditions during an appliance operating cycle. The invention elevates the supported appliance for improved ergonomic use of the appliance by an operator and compliance with ADA.

With passive control, the invention channels leaking liquids directly to a high capacity sump. The sump provides an improved location for a water sensing device, used by an alarm or liquid shut off system, instead of the typical floor location under the appliance. This assures that leaking liquid will be directed towards the sensor regardless of the location of the leak within the appliance. This is important due to the fact that slope and location can affect the ability of a sensor used in passive systems to come in contact with the leaking liquid.

For an active control system, the invention channels liquids to an incorporated sump. This provides containment of the liquid leaked and provides an appropriate location for an active pump system that will discharge the liquid to a nearby drain, standpipe, or disposal means.

The present invention also includes an appliance floatation system that can be activated by a technician or other person to raise the appliance itself or an appliance pedestal supporting an appliance from its contact with the supporting surface such that the technician or other person can easily move the appliance from one location to another.

There is also a system to remove fluids from the bottom of an appliance which may be combined with a floatation system or may be an independent function on its own.

Other features of the present appliance pedestal and system will become more apparent in light of the following detailed description of a preferred embodiment thereof and as illustrated in the accompanying drawings.

### BRIEF DESCRIPTION OF THE DRAWINGS

FIG. 1 is an exploded view illustrating the present invention positioned to support an appliance;

FIG. 2 is a perspective view of appliance pedestal of the present invention;

FIG. 3 is a cutaway, perspective view of the appliance pedestal of FIG. 2;

FIG. 4 is a side view, cut away, illustrating an exemplary embodiment of the present invention incorporating a submersible pump;

FIG. 5 is a side view, cut away, illustrating a further exemplary embodiment of the present invention incorporating a gravity drain;

FIG. 6 is a side view, cut away, illustrating a still further exemplary embodiment of the present invention incorporating a non-submersible pump;

FIG. 7 is a side view, cut away, illustrating a still further exemplary embodiment of the present invention incorporating a liquid sensing device;

FIG. 8 is a perspective view of the appliance pedestal having a drawer provided therein;

FIG. 9 is a side view, cut away, illustrating the embodiment of FIG. 8;

FIG. 10 is a front view, cut away, illustrating the installation of an appliance on the present invention;

FIG. 10A is an enlarged view of a portion of FIG. 10;

FIG. 11 is a front view, cut away, illustrating the affixation of the appliance pedestal of the present invention to a supporting structure, such as a floor;

FIG. 11A and 11B are enlarged views of portion of FIG. 11;

FIG. 12 is a side view of an integral air cushion transport system used with the present appliance pedestal;

FIG. 13 is a bottom view of the air cushion transport system of FIG. 12; and

FIGS. 14A and 14B are, respectively, a bottom view and a sectional view taken along the line A of FIG. 14A illustrating an exemplary embodiment of the present floating system with air pressure applied;

FIGS. 15A and 15B are, respectively, a bottom view and a sectional view taken along the line B of FIG. 15A illustrating another exemplary embodiment of the present floating system with air pressure applied;

FIGS. 16A and 16B are, respectively, a bottom view and a sectional view taken along the line C of FIG. 16A illustrating a further exemplary embodiment of the present floating system with air pressure applied;

FIGS. 17A and 17B are, respectively, a bottom view and a sectional view taken along the line D of FIG. 17A illustrating a still further exemplary embodiment of the present floating system with air pressure applied;

FIGS. 18A-C are, respectively, a side view, a bottom view and a sectional view taken along the line E of FIG. 18B, illustrating an exemplary embodiment of the present floating system with air pressure applied;

FIGS. 19A is a side sectional view illustrating the legs of an appliance supported by a base section;

FIG. 19B is schematic view illustrating the application of air pressure to a base used with the present invention.

FIGS. 20A-20D are schematic views illustrating the method of loading an appliance on to the present invention.

FIGS. 21A-21D are, respectively, a side view, a bottom view, and a sectional view taken along the line A-A of FIG. 21B illustrating an appliance cabinet incorporating the floatation system of the present invention in its at rest position and a sectional view taken along the line A-A of

FIG. 21B of the present floatation system where pressure has been applied;

FIG. 22 is a cutaway view illustrating an appliance cabinet incorporating the appliance floating system of the present invention with a pumping system to remove fluids collected in the bottom of an appliance; and

FIG. 23 is as cutaway view illustrating an alternative system to remove fluids collected in the bottom of an appliance.

### DETAILED DESCRIPTION OF THE INVENTION

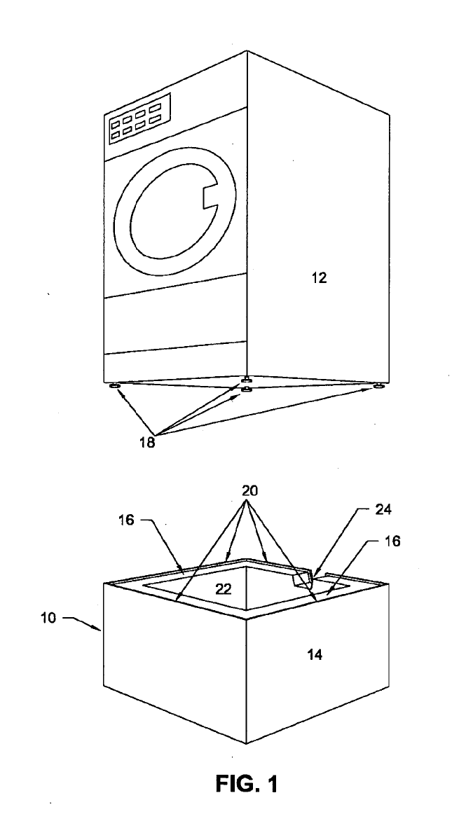

Turning first to FIG. 1, there is shown an exploded view illustrating the appliance pedestal 10 of the present invention in position to support an appliance 12. The appliance 12 is of the type that uses and thus contains a quantity of liquid, typically water, in carrying out its function and may be a clothes washer. As can be seen, the appliance pedestal 10 comprises a housing 14 that is of a three dimensional rectilinear shape and in the illustrated embodiment, the housing 14 is cubical in shape.

The upper surface of the housing 14 is comprised of perimeter rails 16 that support the feet 18 of the appliance 12 supported atop of the housing 14. The perimeter rails 16 have a lip 20 to direct liquids leaking from the supported appliance 12 to the interior and to prevent the appliance 12 from slipping off the perimeter rails 16. The perimeter rails 16 and lip 20 channel liquids to a liquid-tight sump 22 located in the interior of the housing 14. The liquid-tight sump 22 is sized and positioned so that all liquid leaking from the appliance 12 is directed from the perimeter rails 16 and lip 20 to be collected at this single location, however, because the appliance 12 is supported by the upper surface of the perimeter rails 16, the liquid that accumulates within the liquid-tight sump 22 remains beneath the appliance 12 and does not create a problem with that liquid contacting the electrical or other functions of the appliance 12. A depression 24 may be provided to allow relief for liquid discharge hoses and external power cords to be later described.

The shape of the housing 14 is not limited to a principally rectilinear or cubical form. A different form than that described in the figures, such as a cylindrical form with principally similar sectional features, would function in a similar fashion.

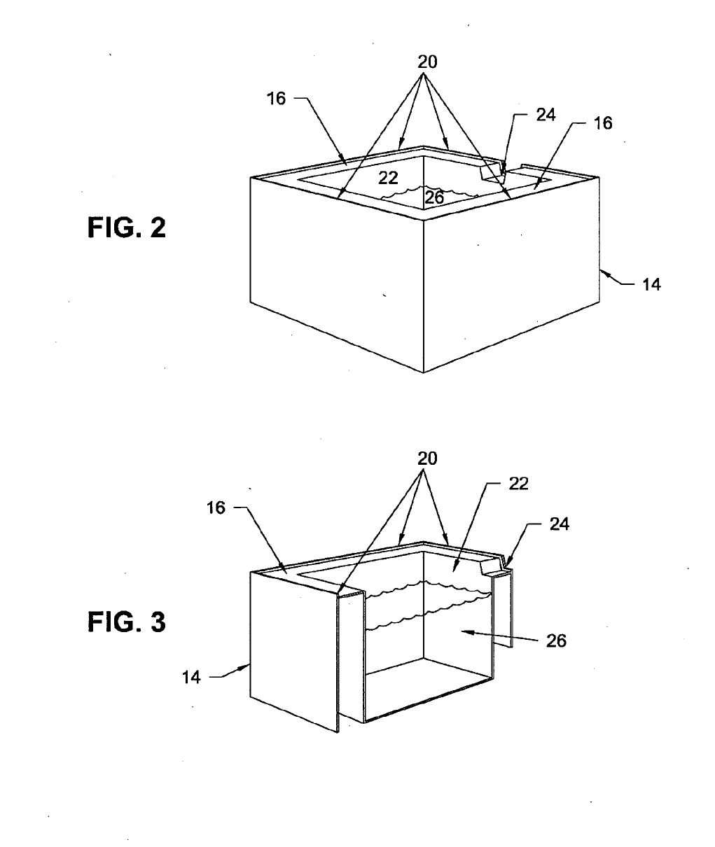

Turning next to FIG. 2, there is shown a perspective view of the housing 14 of the present invention and, as can be seen, the liquid-tight sump 22 contains a quantity of a liquid 26 and the liquid-tight sump 22 holds that liquid therein.

Turning to FIG. 3, there can be seen a cut away perspective view illustrating the level of the liquid 26 contained within the liquid-tight sump 22 and, as can be seen, the level of the liquid 26 stays beneath upper surface of the housing 14 where the appliance 12 is supported.

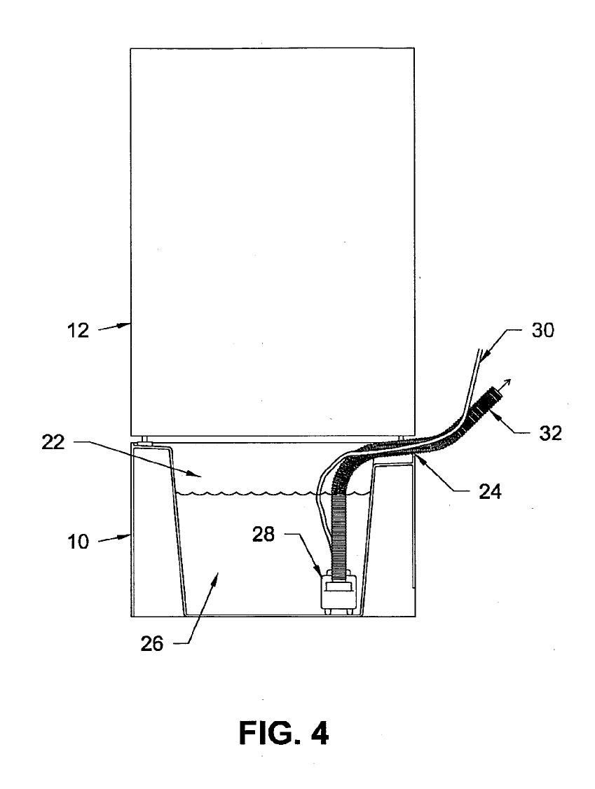

In FIG. 4, there is a side view, cut away, illustrating a discharge system that can be provided to remove liquid from the liquid-tight sump 22. In this embodiment, there is a submersible pump 28 located beneath the level of the liquid 26 in the liquid-tight sump 22 to discharge that liquid from the liquid-tight sump 22. As can be seen, the electrical cable 30 and liquid discharge hose 32 can pass through the depression 24 and out of the liquid-tight sump 22 to engage an elevated drain or stand pipe.

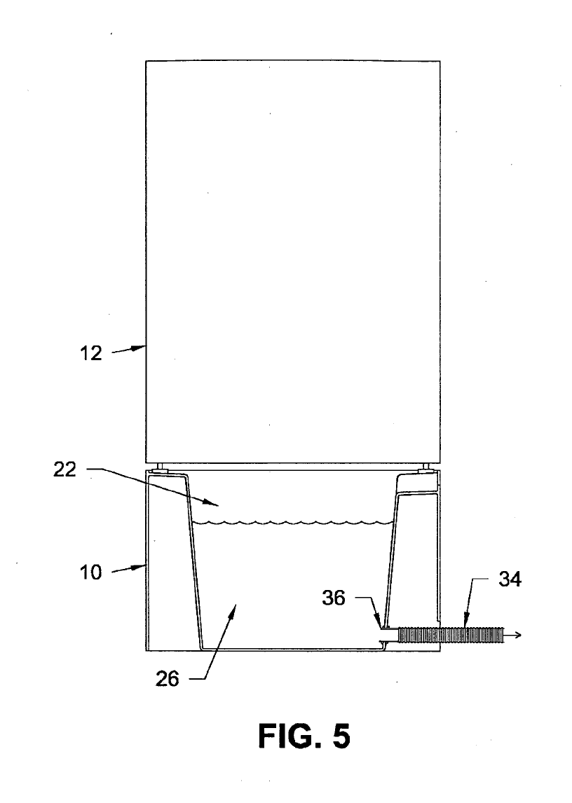

Turning to FIG. 5, there is a side view, cut away, illustrating a discharge system that is passive, that is, there is a standard ground level drain hose 34 as is customary with current drip and catch pans. The liquid-tight sump 22 can have a tap 36 such that the drain hose 34 will dispose collected liquids 26 to a floor or condensate drain by gravity.

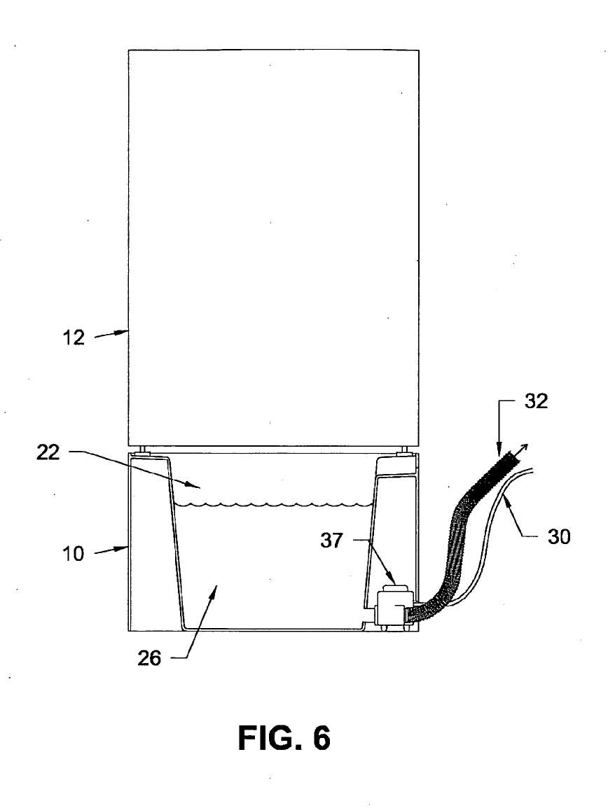

In FIG. 6, there is a side view, cut away, illustrating a discharge system wherein a non-submersible pump 37 can be used to discharge the liquid 26 collected in the liquid-tight sump 22 to a drain or drain standpipe.

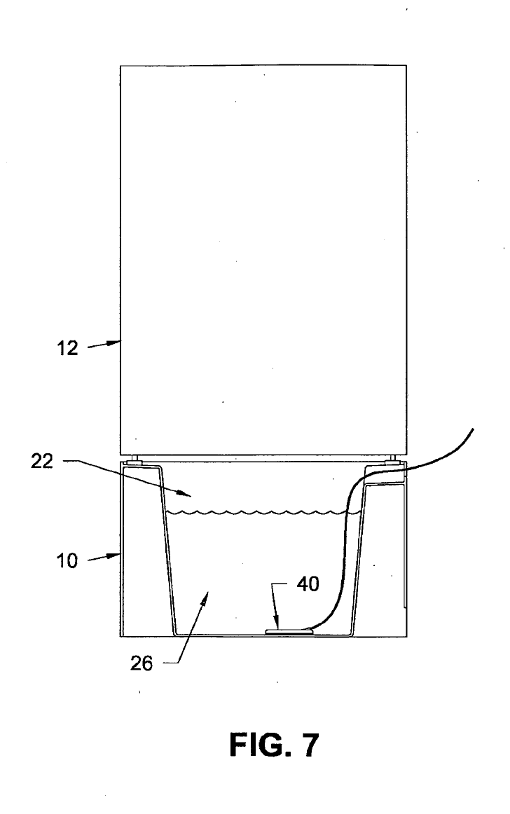

In FIG. 7, there is a side view, cut away, illustrating an exemplary embodiment of the present invention wherein a liquid monitor sensor 40 is located in the liquid-tight sump 22 for a more reliable response to a liquid leak. This liquid monitor sensor 40 would be part of an electric/electronic alarm or liquid shut off system used in conjunction with the invention. The liquid monitor sensor 40 may also be used to shut down any water supply to an appliance pedestal 10 upon the sensing of water in the liquid-tight sump.

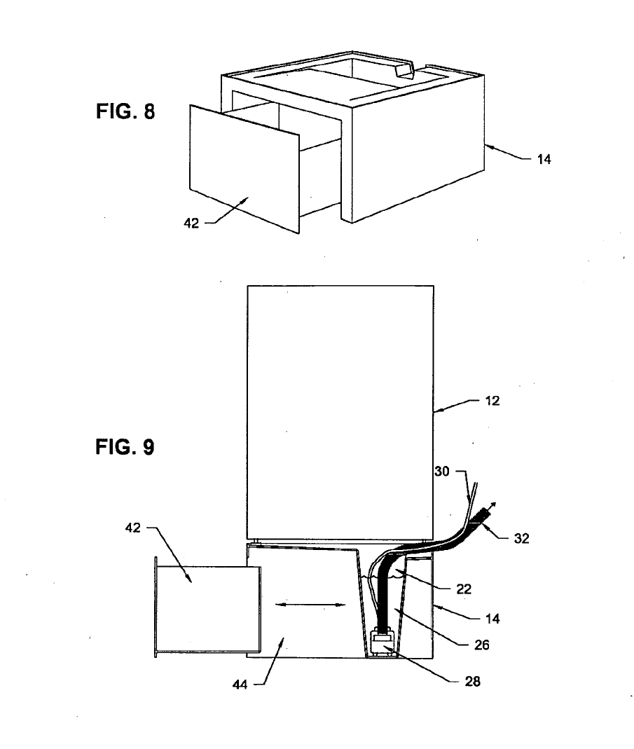

Turning to FIGS. 8 and 9, there are shown perspective views of the housing 14 formed in the shape of a drawer 42 or, in the absence of a drawer, an open compartment 44 that can be left open or be closed by a door.

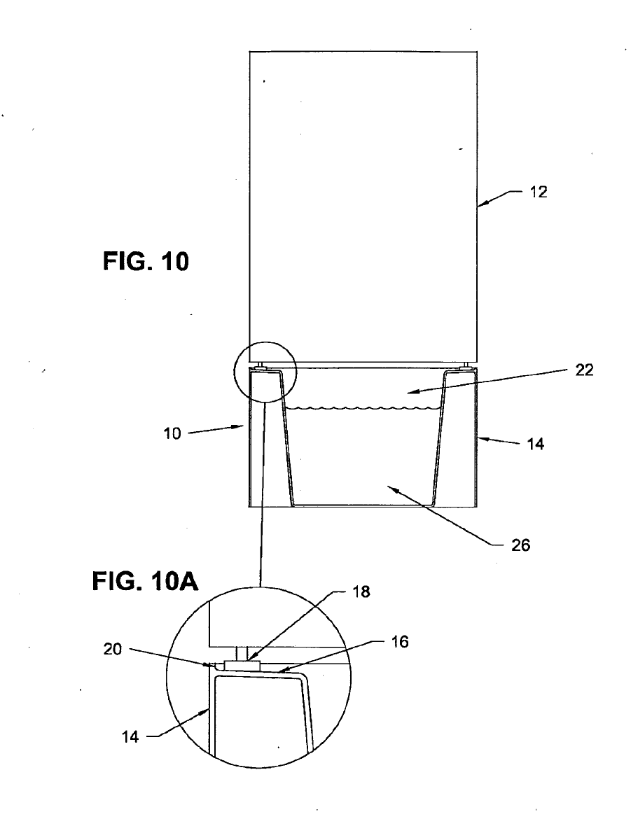

Turning to FIGS. 10 and 10A, there is a cut-away, front view, and an enlarged partial view, respectively, illustrating the lip 20 that controls the “creep” of the supported appliance 12 to prevent the appliance from coming off of the housing 14. The creep or shift usually takes place during rapid ground tremors and during “out of balance” conditions that may be present during some appliance operating cycles. The support perimeter rails 16 have an opposing negative camber of, generally, but not specifically, 3 degrees. This assists the appliance 12 in maintaining a centered position of the appliance 12 eliminating the need to mount the appliance 12 to the housing 14.

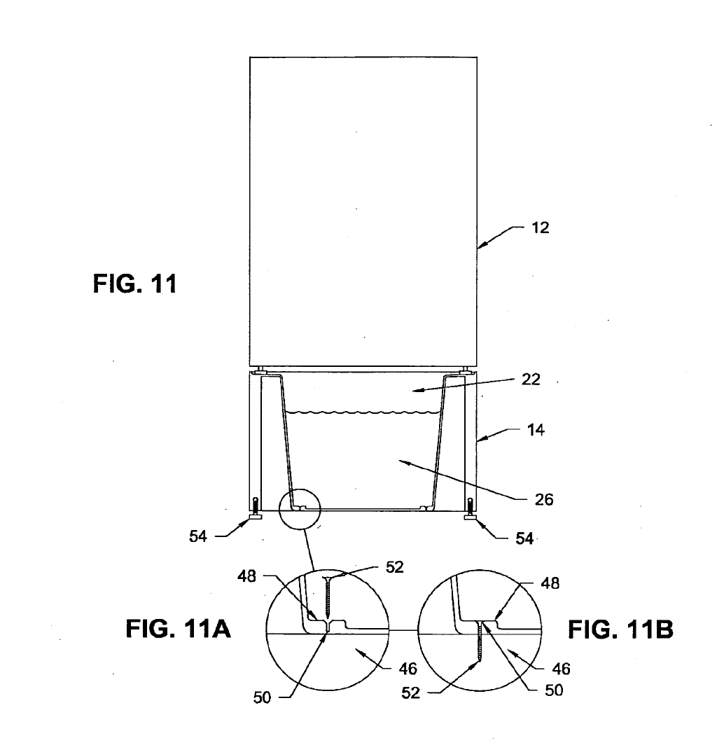

Next, taking FIGS. 11, 11A and 11B, there is a front view, cut away and enlarged views illustrating the mounting or anchoring of the housing 14 to a supporting structure 46 such as a floor. Strengthened screw bosses 48 are located in the bottom of the liquid-tight sump 22. Predrilled holes 50 do not extend all the way through the bosses 48 in order to maintain a liquid-tight condition in the event that they are not used. Thread cutting screws 52 pierce through the bottom of the holes 50 and into the support surface 46. When fully installed, the head of the screw 52 seals itself at the top of the boss 48 and at the upper portion of the hole 50, maintaining a liquid-tight condition after mounting. The invention can accept optional leveling legs 54 of the appliance 12 for extremely unleveled or rough support surfaces.

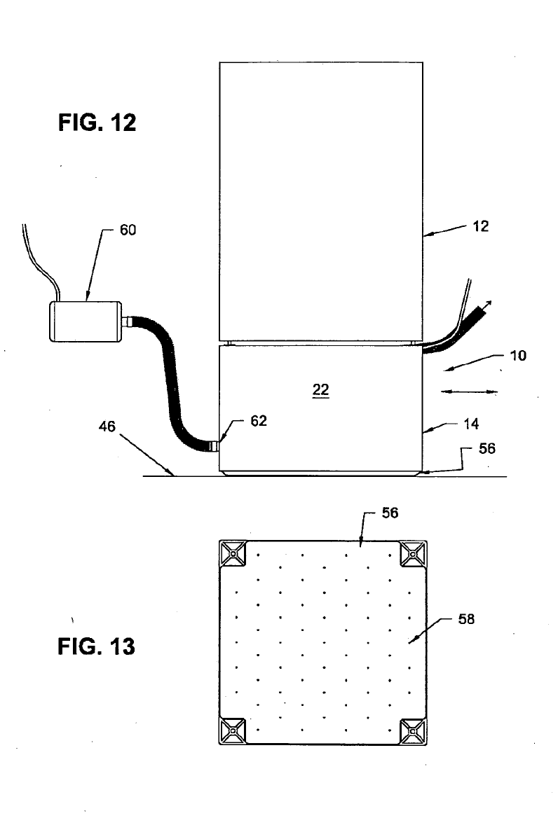

Turning next to FIGS. 12 and 13, there is a side view and a bottom view, respectively, of an exemplary embodiment of the present invention wherein there is an integral air cushion transport system used to facilitate movement of the appliance 12 during installation and maintenance. With this system the appliance pedestal 10 is capable of floating itself and the supported appliance 12 on a cushion of compressed air or gas. A flexible perforated membrane 56 is sealed to the bottom perimeter edges of the housing 14, sealing the internal cavities, external to and below the liquid-tight sump 22.

A pattern of vent holes 58 in the membrane 56 make up the only exit from the sealed cavities within the membrane 56. A blower 60 or other source of pressurized gas connected through an external port 62 pressurizes the internal cavities. The pressurized air or gas vents through the vent holes 58 of the membrane 56 lifting the housing 14 as well as the appliance 12 sufficiently to break the friction between the housing 14 and the support surface 46 making the housing 14 and the appliance 12 combination easily moved. The blower 60 could also be integral to the housing 14. It should be noted that the description of air holes includes slits that may be stamped into the membrane to other material creating the lift.

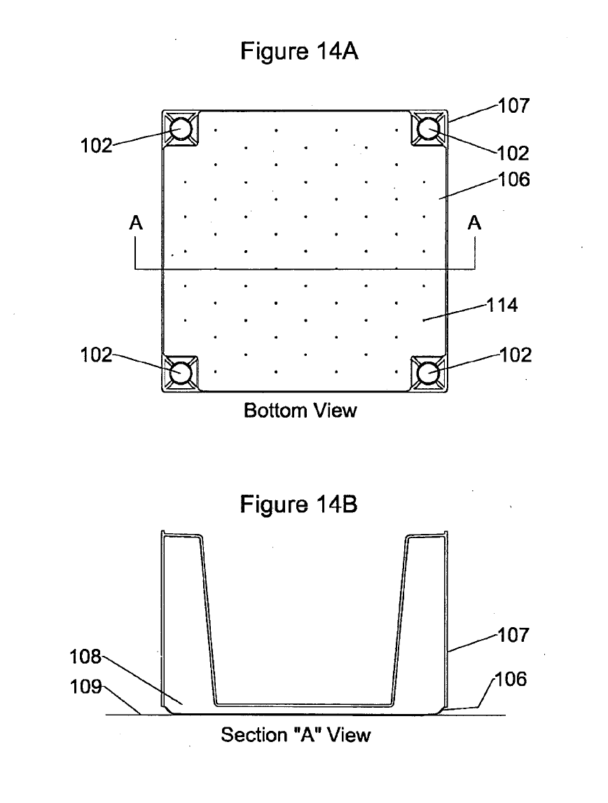

Turning next to FIGS. 14A and 14B, there is shown an appliance pedestal 107 that can be so configured to have a air-tight bottom surface, an air retaining means 106 affixed to the cabinet bottom by its perimeter edge creating a high pressure area 108 that causes the appliance to be lifted or elevated off of its supporting surface 109 when pressurized air is supplied. In the configuration shown, the air retaining means 106 consists of a flexible sheet material such as plastic, coated fabric, or some other suitable material which contains a pattern of perforations 114 that allow some of the pressurized air to escape between the air retaining means 106 and the support surface 109. This provides an air bearing so to reduce or eliminate friction between the two surfaces and allows the elevated appliance to be moved horizontally on its supporting surface 109. When the air supply is removed, the appliance returns to rest on its legs 102, or bottom surface if legs are not incorporated, where it once again becomes stationary.

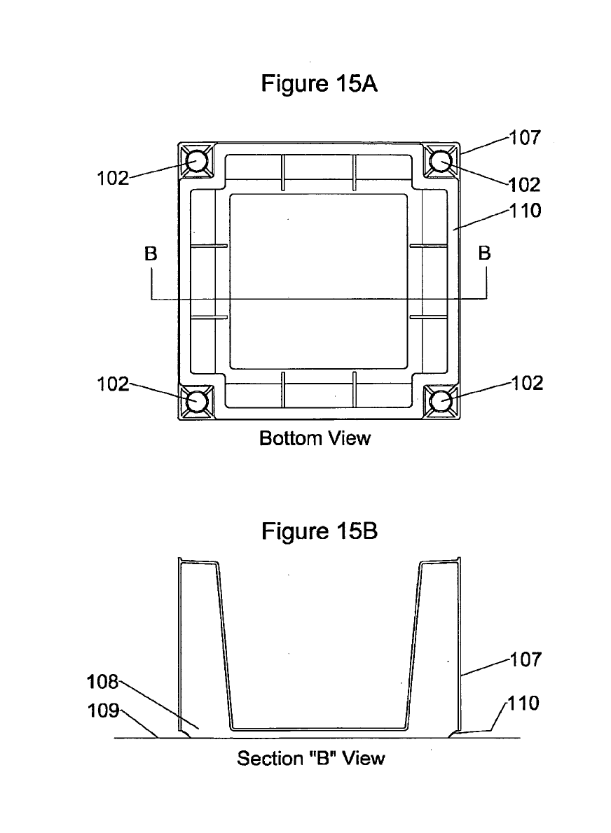

Turning to FIGS. 15A and 15B, there is shown a somewhat similar configuration to FIGS. 14A and 14B that substitutes a flexible seal 110 for the perforated sheet 106 as the pressurized air retaining means. In a similar manner, the flexible seal 110 is affixed to the appliance pedestal 107 at its perimeter edge. When pressurized air is supplied, the seal 110 flexes downward as the pedestal 107 is lifted to maintain the air seal between the cabinet 107 and the supporting surface 109. The contact area and the corresponding friction between the flexible seal 110 and the supporting surface 109 are minimal, allowing for horizontal movement of the appliance. When the air supply is removed, the appliance returns to rest on its legs where it once again becomes stationary.

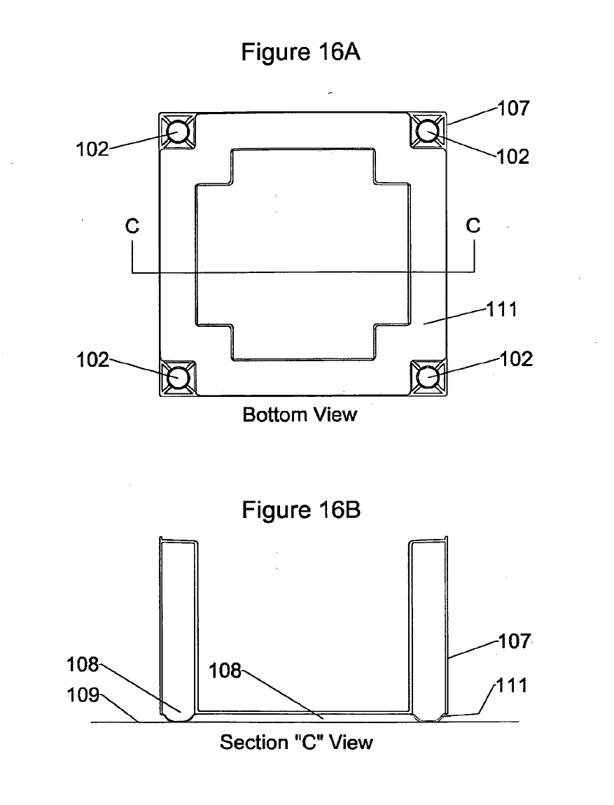

Turning next to FIGS. 16A and 16B, the is a further exemplary embodiment that is somewhat similar configuration to FIGS. 14A-14B and 15A-15B that substitutes a flexible pressurized tubular seal 111 as the pressurized air retaining means. In a similar manner, the flexible seal 111 is affixed to the appliance pedestal 107 at its perimeter edge. When pressurized air is supplied, the seal 111 is forced downward as the pedestal 107 is lifted to maintain the air seal between the pedestal 107 and the supporting surface 109. Some pressurized air escapes between the tubular seal 111 and the support surface 109. This provides an air bearing so to reduce or eliminate friction between the two surfaces and allow the elevated appliance to be moved horizontally on the supporting surface 109. When the air supply is removed, the appliance returns to rest on the legs 102 where it once again becomes stationary.

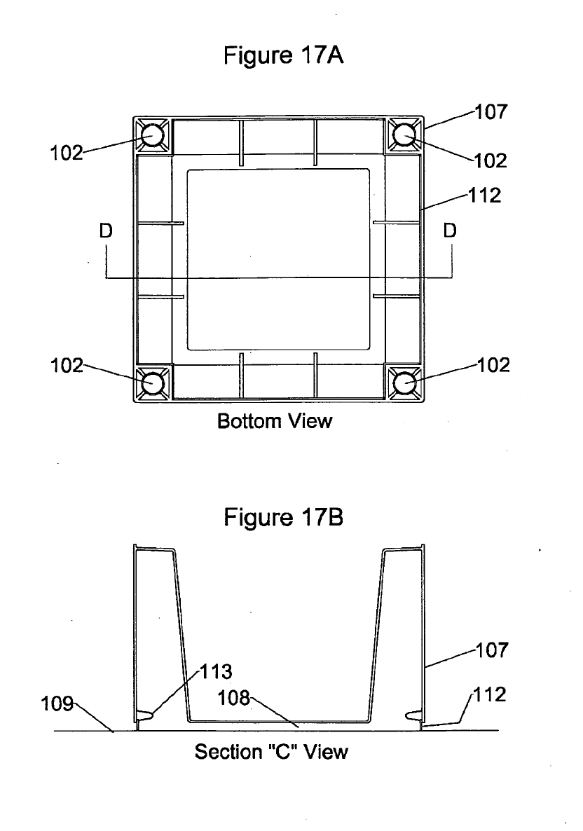

Turning to FIGS. 17A and 17B, there is a further exemplary embodiment of the present floating system wherein a rigid floating seal 112 is provided as the pressurized air retaining means. The rigid floating seal 112 is not affixed to the appliance pedestal 107 at its perimeter edge but is allowed to rest on the supporting surface 109 and float up and down in relation to the pedestal 107. When pressurized air is supplied, the seal 112 is forced downward by gravity or a device such as a spring 113 as the pedestal 107 is lifted to maintain the air seal between the pedestal 107 and the supporting surface 109. The contact area and the corresponding friction between the rigid seal 112 and the supporting surface 109 are minimal, allowing for horizontal movement of the appliance. When the air supply is removed, the appliance returns to rest on its legs 102 where it once again becomes stationary.

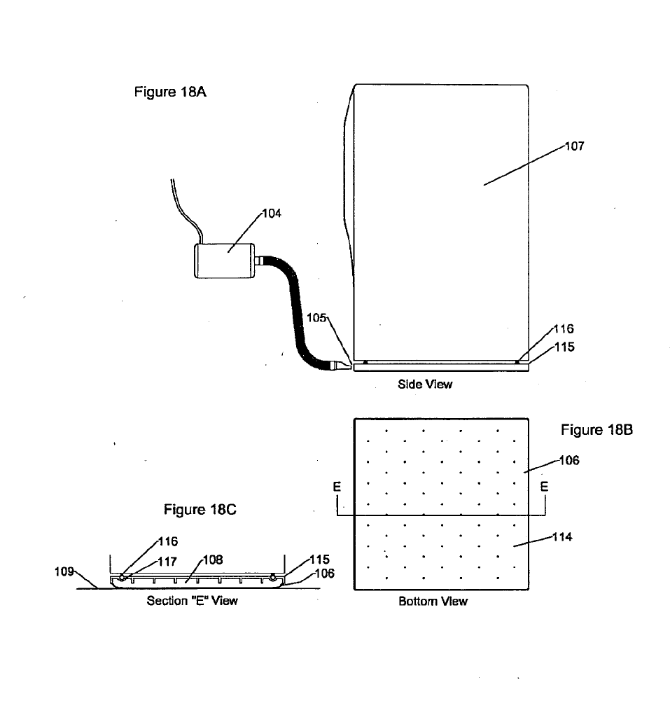

Turning next to FIGS. 18A-18C, there is shown a further method of lifting or floating the appliance but in a configuration that can be applied to existing cabinet designs. The previously illustrated air lift methods can all work but this embodiment places the air lift means between the adjustable leveling legs and the support surface.

The entire lifting means 115 replaces the function of the “foot” portion of the leveling legs 102 (FIG. 17A) currently used. A post 116 of similar configuration to the original leg 102 is shown with its upper end contacting the cabinet 107 and with a “ball” or some other interlocking or press fit configuration at its lower end, as originally designed, and affixed into a socket 117 below in the lifting means 115. The post 116 can be rotated to accomplish leveling at the corresponding corners. This accomplishes both the leveling feature of the original design and the air lift feature of the new art without modification the appliance or an accessory pedestal.

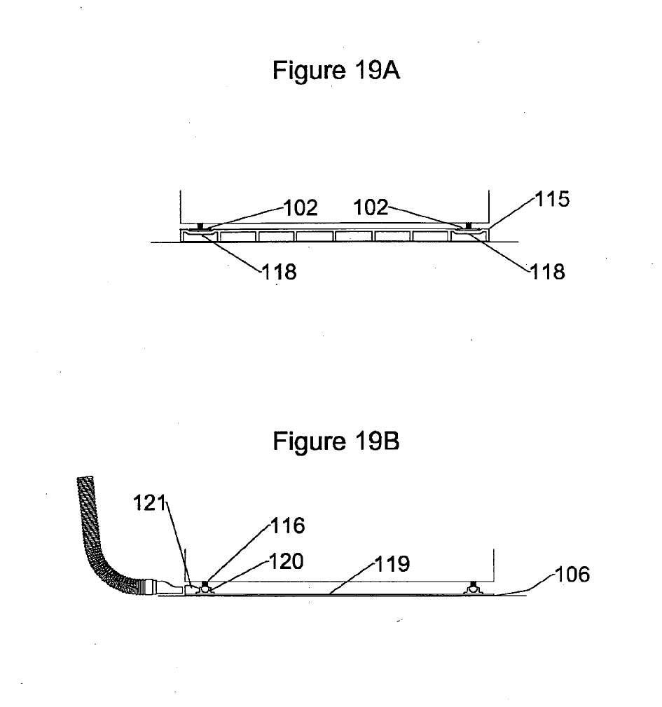

Turning now to FIG. 19A and 19B, there is shown a side sectional view and a schematic view of an appliance supported by a base section. FIG. 19A illustrates the use of a detent, depression, or socket area 118 that would accommodate the original leveling leg 102 by having the appliance “rest” by gravity on the air lift means.

FIG. 19B illustrates a configuration of a thin plate 119 for the air lift structure instead that of a molded or fabricated thicker structure as previously shown. Posts 116 and sockets 120 can be affixed to or stamped into the plate 119 to accomplish a connection between the cabinet and the air lift means. This requires the addition of a top surface port 121 to receive pressurized air. This port may be fixed or removable.

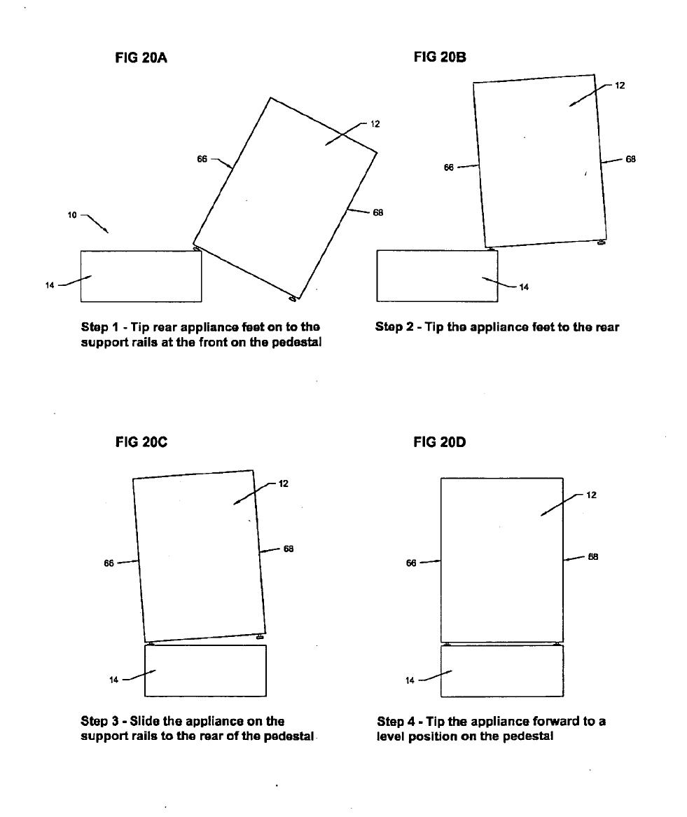

Turning to FIGS. 20A-20D, there are shown schematic views illustrating a method of installing and/or removing an appliance 12 to and from an appliance pedestal 10. As will be used to describe the method, the appliance 12 has a rearward side 66 that will be the side toward which the appliance 12 moves in installing it onto the housing 14 and a forward side 68 that is opposite thereto. Accordingly, as shown in FIG. 20A, in installing the appliance 12 onto the housing 14, the appliance 12 is initially tipped forwardly so as to elevate the rearward side 66 to rest it atop of the housing 14. The forward side 68 is then elevated to just above the height of the housing 14 as shown in FIG. 20B, that is, by a rearward tipping motion, and slid on its rearward side 66 into the position shown in FIG. 20C. At the position of FIG. 20C, the forward side 68 is then lowered to a generally horizontal orientation to rest on the housing 14 such that the appliance 12 can be readily installed atop of the housing 14 easily and with a minimum of manipulations in close quarters. All this is accomplished without lifting the full weight of the appliance greatly reducing the physical strain on the installer or maintenance technician. Uninstallation is accomplished by reverse order or this method.

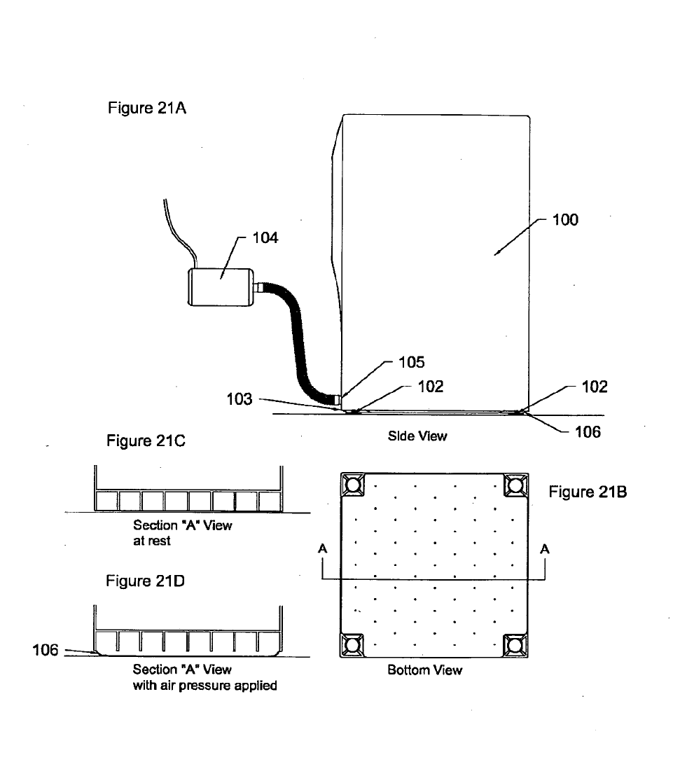

Turning to FIGS. 21A-21D, there is shown a side view, a bottom view and a sectional view illustrating the at rest status and pressurized status, respectively, of an appliance 100 such as a clothing washer, dryer, refrigerator, stove or likewise, equipped with or without leveling legs 102. The appliance 100 may be equipped with an air-tight bottom surface with an air retaining means 106 affixed to the cabinet bottom by its perimeter edge creating a high pressure area that causes the appliance to be lifted or elevated off of its supporting surface when pressurized air is supplied. As described herein, the systems that can be used incorporated into an appliance can operate on the same principles and with the same basic components as previously described herein with respect to an appliance pedestal for the floating systems and the water handling systems.

Again, the air retaining means 106 consists of a flexible sheet material such as plastic, coated fabric, or some other suitable material which contains a pattern of perforations 114 that allow some of the pressurized air to escape between the air retaining means 106 and the support surface 109. This provides an air bearing so to reduce or eliminate friction between the two surfaces and allows the elevated appliance to be moved horizontally on its supporting surface 109. When the air supply is removed, the appliance returns to rest on its legs 102, or bottom surface if legs are not incorporated, where it once again becomes stationary. An air pump 104 can be connected externally at a port 105 or incorporated internally to the cabinet to supply pressurized air to lift and float the appliance 100 on its supporting surface.

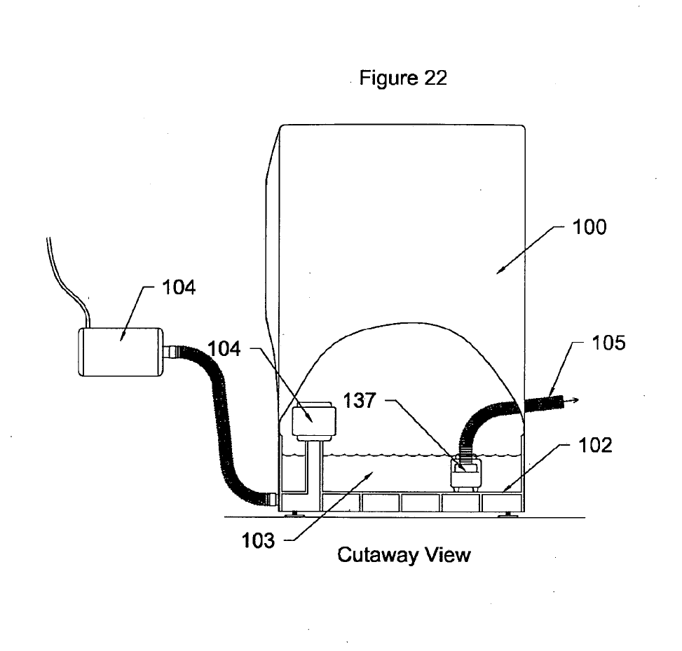

Turning now to FIG. 22 there is shown an appliance 100 with a fluid impervious bottom 102. Fluids 103 collect in the bottom. A pump 104 which may be internal, as shown, or external, can discharge the collected fluids to an appropriate drain or collection system. The attached hose 105 may be a separate discharge hose, as shown, or may be an existing discharge hose such as would be present for a clothes or dish washer.

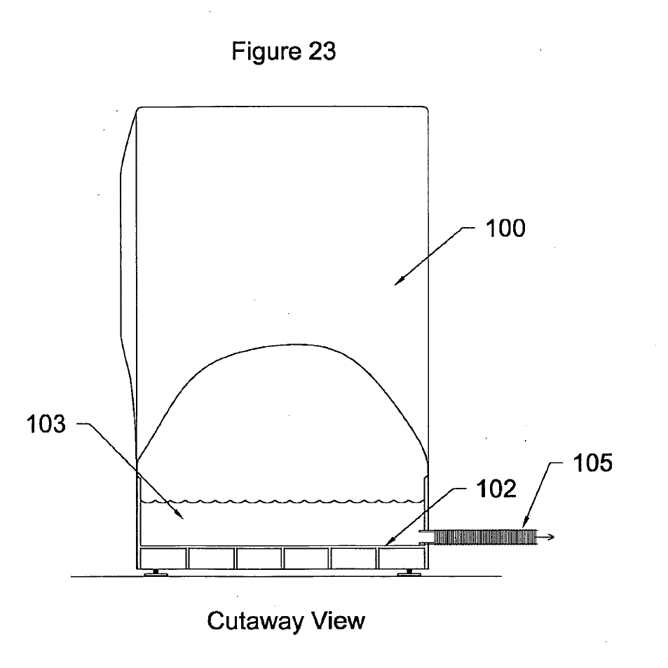

Turning, finally, to FIG. 23, there is shown an appliance 100 with a fluid impervious bottom 120. Fluids 103 collect in the bottom. Collected fluids 103 can be drained by gravity or suction to a suitable drain or collection chamber.

The present invention supports liquid leak control in both a passive and active manners. For passive control, the present invention provides three methods of improved control. The first is a much higher volume of liquid retention that that of present art. The invention will retain the collected liquids without causing additional degradation of the appliance or the electrical hazards caused by liquid immersion. The second passive control improvement is by directing leaking liquids directly to a liquid sensing device. By providing an improved location for a water sensing device instead of the typical floor location under or in close proximity to the equipment being monitored, assures that leaking liquids will be directed towards the sensor regardless of the location of the leak within the appliance. This is important due to the fact that slope and location can affect the ability of a liquid sensor to come in contact with the leaking liquid. The third method for passive control is supporting gravity discharge of collected liquids to a floor level drain. The invention also provides active control by forcefully discharging leaking liquids by means of an automatic pump to an elevated drain, standpipe, or remote location. Active control can utilize existing elevated and remote drain systems thereby greatly reducing plumbing and construction costs.

As can now be seen, the present invention can have both an integral air cushion transport system as well as a liquid leak control system, that is, the invention itself may include a passive or active leak control system using a internal liquid pump, an external liquid pump, or simply use a gravity drain system. At the same time, the invention can also include an integral air cushion transport using an external air source/pump or an internal air source/pump. As such, both systems can be incorporated into an appliance pedestal to facilitate improved ergonomic appliance work height and have the advantages of the systems combined for preventing damage from liquid leakage as well to facilitate the movement of the appliance, reducing manpower requirements and work related injuries during installation and maintenance of supported appliances.

It can also be seen the all of the described water control and air transport functions and their respective advantages can be incorporated directly into the design of the appliance cabinet. It has further been described that the air transport system can be configured in an extremely low rise form that can be easily retrofitted to existing appliances when height restrictions apply.

The invention can be fabricated, molded, cast, pressure formed, or machined of structural materials depending on desired material properties or manufacturing processes available. This invention incorporates functions of liquid leak control into an elevating pedestal.

While the present invention has been set forth in terms of a specific embodiment or embodiments, it will be understood that the appliance pedestal and floatation system herein disclosed may be modified or altered by those skilled in the art to other configurations. Accordingly, the invention is to be broadly construed and limited only by the scope and spirit of the claims appended hereto,

What is claimed is:

1. An appliance pedestal comprising:
a housing forming a liquid-tight sump, said housing having an upper surface adapted to support an appliance containing a liquid, the liquid-tight sump located underneath the upper surface to receive liquid contained within the appliance, a discharge system for removing liquid from the liquid-tight sump.

2. The appliance pedestal of claim 1 wherein the upper surface comprises an upper perimeter edge having an outer lip that at least substantially surrounds an appliance resting on the appliance pedestal.

3. The appliance pedestal of claim 1 wherein the discharge system includes a pump that pumps the water from the liquid-tight sump.

4. The appliance pedestal of claim 3 wherein the upper surface comprises an upper perimeter edge having a depression and the pump includes a discharge hose that passes through the depression.

5. The appliance pedestal of claim 3 wherein the pump is a submersible pump adapted to be located in liquid contained within the liquid-tight sump.

6. The appliance pedestal of claim 3 wherein the discharge system includes a non-submersible pump that pumps liquid from the liquid-tight sump.

7. The appliance pedestal of claim 1 wherein discharge system includes an outlet located at a bottom of the liquid-tight sump to allow liquid to be discharged from, the liquid-tight sump by gravity.

8. The appliance pedestal of claim 1 wherein the pedestal includes a liquid sensor located in the liquid-tight sump to sense the presence of liquid therein.

9. The appliance pedestal of claim 8 wherein the liquid sensor provides a visual or audible indication of the presence of a liquid in the liquid-tight sump

10. The appliance pedestal of claim 8 further including a water supply to the appliance and wherein the liquid sensor controls the water supply to the appliance.

11. The appliance pedestal of claim 1 wherein a drawer is provided in the housing.

12. The appliance pedestal of claim 1 wherein the housing includes screw bosses having partial holes therein adapted to receive thread cutting screws to firmly affix the housing to a supporting structure.

13. The appliance pedestal of claim 1 wherein the housing includes an integral air cushion transport system to facilitate movement of the housing across a support structure.

14. The appliance pedestal of claim 13 wherein the air cushion transport system comprises a flexible perforated membrane having vent holes mounted beneath the housing and a means to pressurize the membrane to emit gas through the vent holes to float the housing on the support surface.

15. The appliance pedestal of claim 14 wherein the means to pressurize the membrane comprises an air pump.

16. A method of positioning an appliance having a forward side and a rearward side atop of a housing having a height as defined in claim 1 comprising the steps of:
elevating the rearward side of the appliance to at or slightly above the height of the housing and positioning the rearward side of the appliance atop of the housing;
tipping the appliance slightly rearwardly;
sliding the appliance in that rearwardly tipped orientation rearwardly to be positioned fully over the housing; and
returning the appliance to a level orientation resting atop of the housing.

17. A method of capturing a liquid leaking for an appliance utilizing a liquid, the method comprising the steps of:
providing a housing having a liquid-tight sump and having an upper perimeter edge,
positioning an appliance to rest on the upper perimeter surface of the housing above the liquid-tight sump, and
removing liquid that accumulates in the liquid-tight sump.

18. The method of claim 17 wherein the step of removing liquid from the liquid-tight sump comprises pumping the liquid out of the liquid-tight sump.

19. The method of claim 17 wherein the step of removing liquid from the liquid-tight sump comprises providing a drain in the liquid-tight sump and allowing liquid to pass through the drain by gravity.

20. An appliance pedestal comprising:
a housing forming a liquid-tight sump, said housing having an upper surface adapted to support an appliance containing a liquid, the liquid-tight sump located underneath the upper surface to receive liquid contained within the appliance,
a discharge system for removing liquid from the liquid-tight sump, and
an air cushion transport system to facilitate movement of the housing across a support structure.

21. An appliance pedestal of claim 20 wherein the discharge system and air cushion transport system are both built into the appliance pedestal.

22. An appliance pedestal of claim 20 wherein the discharge system includes an external liquid pump.

23. An appliance pedestal of claim 20 wherein the air cushion transport system includes an air pump that is external of the pedestal.

24. An appliance pedestal of claim 20 wherein both the air cushion transport system and the discharge system include pumping systems that are external of the pedestal.

25. An appliance pedestal of claim 20 wherein both the air cushion transport system and the discharge system include pumping systems that are internal of the pedestal.

26. A system for facilitating the movement of an appliance resting on a supporting surface comprising:
a chamber located at or proximate to the bottom of the appliance, the chamber having a plurality of openings facing downwardly toward the supporting surface,
a means to pressurize the chamber to produce a plurality of fluid jets exiting from the openings to raise the appliance off of the supporting surface whereby the appliance is readily moved along the supporting surface.

27. An appliance comprising:
a housing adapted to rest upon a supporting surface, the housing having a bottom,
a fluid chamber located proximate to the bottom of the housing,
a source of fluid under pressure,
a fluid system to introduce the fluid under pressure to the fluid chamber to raise the appliance with respect to the supporting surface to float the appliance on the supporting surface.

28. The appliance of claim 27 wherein the fluid system includes a flexible, tubular seal affixed to the bottom of the appliance that is pressurized to raise the appliance with respect to the supporting surface to float the appliance on the supporting surface.

29. The appliance of claim 27 wherein the fluid system includes a perimeter lip seal that forms a chamber that is pressurized rigid floating seal that is forced downwardly by the fluid under pressure while maintaining an air seal between the appliance and a supporting surface to lift the appliance with respect to a supporting surface.

30. The appliance of claim 27 wherein the fluid system includes a rigid floating seal that is forced downwardly by the fluid under pressure while maintaining an air seal between the appliance and a supporting surface to lift the appliance with respect to a supporting surface.
